(19) United States
(12) Patent Application Publication
(10) Pub. No.: US 2012/0126989 A1
(43) Pub. Date: May 24, 2012

(54) METHOD FOR DIAGNOSING A FAULT OF AN SCR SYSTEM

(75) Inventors: Roberto VERNASSA, Volpiano (IT); Ignazio DENTICI, Torino (IT)

(73) Assignee: GM GLOBAL TECHNOLOGY OPERATIONS LLC, Detroit, MI (US)

(21) Appl. No.: 13/302,032

(22) Filed: Nov. 22, 2011

(30) Foreign Application Priority Data
Nov. 23, 2010 (GB) 1019803.4

(51) Int. Cl. G08B 17/10; G06F 19/00

(52) U.S. Cl. 340/606; 702/114

(57) ABSTRACT

A method is provided for diagnosing a fault in a selective catalytic reduction system having an electric driven transportation device that provide a mass flow of a Diesel Exhaust Fluid into the selective catalytic reduction system. The method includes, but is not limited to applying an electric signal to the transportation device for establishing the mass flow, monitoring a parameter value of the electric signal, monitoring the mass flow provided into the selective catalytic reduction system caused by the transportation device when it is driven with the signal, determining, for the monitored mass flow, the difference between the corresponding parameter value, and a corresponding parameter value stored in a data map.

### CROSS-REFERENCE TO RELATED APPLICATION

This application claims priority to British Patent Application No. 1019803.4, filed Nov. 23, 2010, which is incorporated herein by reference in its entirety.

### TECHNICAL FIELD

The technical field relates to a fault diagnostic method for a Selective Catalytic reduction (SCR) system provided in diesel engines working in the reduction of the NOₓ emissions.

### BACKGROUND

It is known that SCR systems in Diesel engines are able to achieve a reduction of NOₓ emissions by feeding in the exhaust pipe a Diesel Exhaust Fluid (DEF). An example of such fluid, commercially available and used in automotive application, is a solution made up by 32.5% Urea mixed with de-ionized water that is maintained at a suitable pressure set point by a pressure regulation circuit. The DEF is fed in the exhaust gas by a transportation device which comprises a dedicated DEF injector mounted on the exhaust pipe, in such a way that it can be mixed to the exhaust gas taking advantage of the exhaust gas flow. The SCR catalyst is mounted downstream the DEF injector, respect to the exhaust gas flow, so that the DEF added to a stream of exhaust gas is absorbed inside the catalyst, where due to the temperature of the system the nitrogen oxides are converted according to the following chemical equation (stoichiometric reaction):

4NO+2(NH₂)₂CO+O₂->4N₂+4H₂O+2CO₂

The DEF injector is connected through a pressure line to a pressure pump for supplying to the injector a DEF stored in a DEF tank. The operations of the DEF injector and of the pressure pump are controlled by means of a pressure regulator, integrated in an electronic control module (ECM). The pressure regulator reads a pressure value from a pressure sensor located in the pressure line, and compares the read pressure value with a predetermined one. Based on the result of the comparison, the electronic control module generates and sends an electrical command, for example an electric signal, to the pressure pump in order to maintain the predetermined pressure set point value for the DEF injector. In fact, the accuracy of the DEF injected quantity is strictly dependent on the pressure in the line.

In case of a pressure system fault, which can be identified in a pump leakage, a pressure line leakage (faults that bring to pressure drop), injector malfunctioning (pressure drop or raise) or pressure line occlusion (e.g., due to urea freezing pressure raise), the pressure regulator does not work properly and the injected DEF quantity, necessary for NOx reduction, is not correct. This behavior has effects on NOx emissions fulfillment.

At least a first object is to provide a fault diagnostic method for SCR systems in diesel engines working in the reduction of NOx emissions, which allows the pressure regulator to work properly and to inject a correct DEF quantity necessary for NOx reduction. At least a further object is to provide a method of diagnosing a fault for SCR systems in order to compensate system aging. In addition, other objects, desirable features, and characteristics will become apparent from the subsequent summary and detailed description, and the appended claims, taken in conjunction with the accompanying drawings and this background.

### SUMMARY

A first embodiment provides a method for diagnosing a fault in a selective catalytic reduction system connected to a diesel engine, the selective catalytic reduction system having an electric driven transportation device for providing a mass flow of a Diesel Exhaust Fluid into the selective catalytic reduction system, said method comprising the following steps of: applying an electric signal to the transportation device for establishing the mass flow, monitoring a parameter value of the electric signal, monitoring the mass flow provided into the selective catalytic reduction system caused by the transportation device, which can be a pump, when it is driven with said signal, determining, for a mass flow, the difference between the corresponding parameter value, and a corresponding parameter value stored in a data map, said map containing values of said parameter and correlating them with the mass flow achieved by said transportation device when it is driven with the signal having such a parameter value, and diagnosing a fault in the selective catalytic reduction system if the difference exceeds a threshold. This embodiment has the advantage to allow the detection of a leakage or obstruction in the Diesel Exhaust fluid transportation device.

According to a first embodiment, the map is empirically determined, under predetermined operating condition of the diesel engine, so to allow the use of the same map for all the engines of the same kind. According to a further embodiment, the map is replaced by a new map correlating a diesel exhaust fluid mass flow rate, fed in the selective catalytic reduction catalyst system, with the parameter value of the electric signal, the new map being created with a determined frequency during normal engine operation. The frequency with which the new map is created is determined based on the numbers of hours of operation of the engine or, alternatively of the distance covered by a vehicle provided with the engine. This has the advantage to keep into consideration the tolerance of the parameter value of the electric signal due to pressure system components production dispersion and aging, and operating conditions.

According to a further embodiment, the method comprises the step of activating a warning signal if the fault is diagnosed. This embodiment allow to alert the user that a fault has been diagnosed giving him the opportunity to take the proper countermeasures.

The method can be realized in the form of a computer program comprising a program-code to carry out all the steps of the method and in the form of a computer program product comprising means for executing the computer program. The computer program product comprises, according to an embodiment, a control apparatus for an IC engine, for example the ECU of the engine, in which the program is stored so that the control apparatus operates in the same way as the method. In this case, when the control apparatus executes the computer program all the steps of the method according to the invention are carried out.

The method can be also realized in the form of an electromagnetic signal, the signal being modulated to carry a sequence of data bits that represent a computer program to carry out the steps of the method. An internal combustion engine is also provided that is specially arranged for carrying out the method.

### BRIEF DESCRIPTION OF THE DRAWINGS

The present invention will hereinafter be described in conjunction with the following drawing figures, wherein like numerals denote like elements, and:

FIG. 1 is a schematic representation of an SCR system associated to an internal combustion engine for a NOₓ reduction strategy and suitable for the actuation of an embodiment of the method; and

FIG. 2 shows the chart of the correlation between the requested DEF mass and a parameter of an electric signal sent to the pressure pump in the DEF pressure regulating circuit of FIG. 1.

### DETAILED DESCRIPTION

The following detailed description is merely exemplary in nature and is not intended to limit application and uses. Furthermore, there is no intention to be bound by any theory presented in the preceding background or the following detailed description.

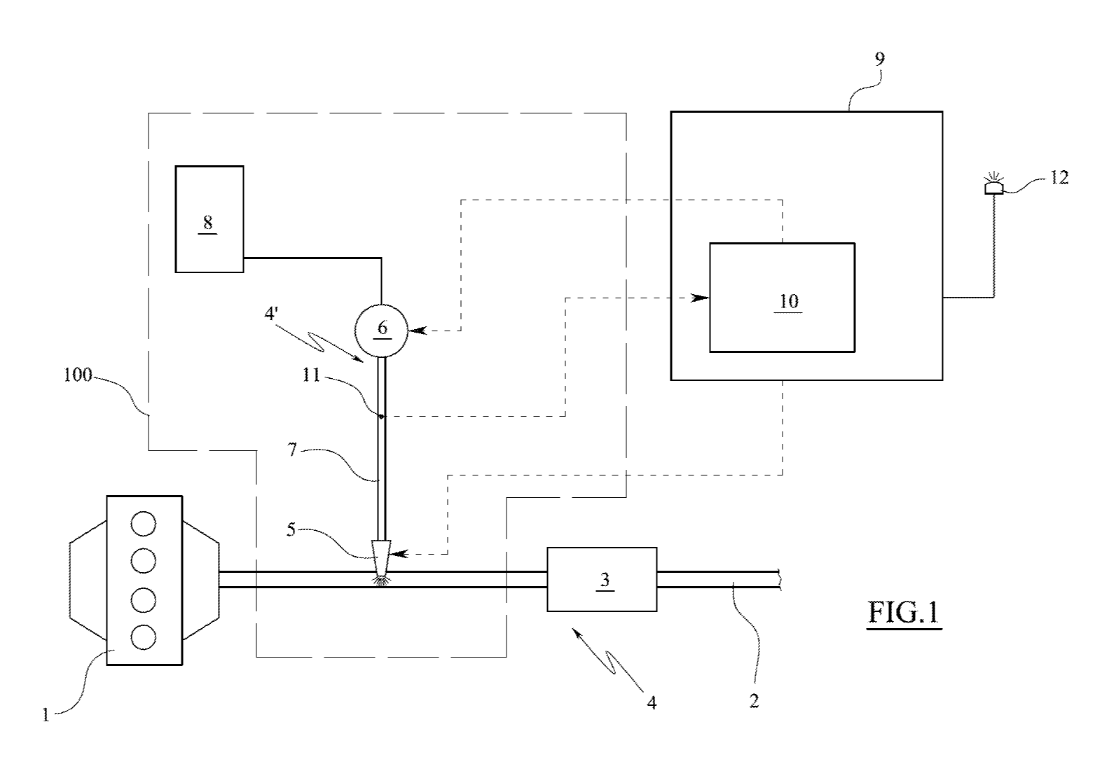

A first embodiment is now described with reference to the accompanying drawings. FIG. 1 shows an internal combustion diesel engine 1 provided connected to a selective catalytic reduction (SCR) system 4 that comprises an SCR catalyst 3, provided in an exhaust pipe 2 connected to the engine. The selective catalytic reduction (SCR) system 4 has a transportation device 100 for providing a mass flow of a diesel emission fluid into the SCR system 4. In detail, the selective catalytic reduction (SCR) system 4, working based on an SCR reduction strategy, feds in the exhaust pipe 2, upstream the SCR catalyst 3, a diesel exhaust fluid (DEF).

According to an embodiment illustrated in FIG. 1 the transportation device 100 comprises a circuit 4′ for supplying a Diesel Exhaust Fluid (DEF) mass flow rate to an injector 5, located upstream the SCR catalyst 3. The circuit 4′ comprises a pressure pump 6 and a pressure line 7 connecting the pump 6 to the injector 5. The pressure pump 6 is configured to supply to the injector 5 a DEF from a tank 8 wherein the DEF is stored. The operation of the transportation device 100 of the SCR system 4 is controlled by an Electronic control module (ECM) 9 based on a SCR reduction strategy.

The ECM 9 comprises a pressure regulator 10, which reads a pressure value from a pressure sensor 11 inserted in the pressure line 7, and compares the read pressure value with a predetermined set point value. The Electronic control module 9, on the basis of result of the comparison, generates and sends an activating electric signal to the transportation device 100, in particular to the pressure pump 6, so that the pressure pump 6 works maintaining the predetermined pressure set point for the injector 5, typically 5 bar. In fact, the accuracy of the DEF injected mass is strictly dependent on the pressure value in the pressure line 7.

In detail, the electronic control module regulates a parameter value of the electric signal as a function of the pressure value read by the pressure sensor 11. According to an embodiment, the electric signal is a power width modulated signal (PWM) and the parameter, which is regulated by the electronic control module, is a duty cycle of the PWM signal.

The SCR system 4 comprises a map correlating a DEF mass flow rate, fed in the SCR system 4, with the parameter value of the electric signal generated by the electronic control module 9. This map is empirically determined under predetermined operating condition of the engine, for instance when the SCR system is new and correctly working. Hence, the electronic control module 9 works to maintain a predetermined pressure set point generating and sending to the pressure pump 6 an electric signal for any injection mass flow rate requested by the SCR reduction strategy. The pressure shall be stable in each operating condition for the injector 5, from zero injected quantity, injector 5 closed, up to maximum injected quantity, injector 5 fully open, and during the whole intermediate range.

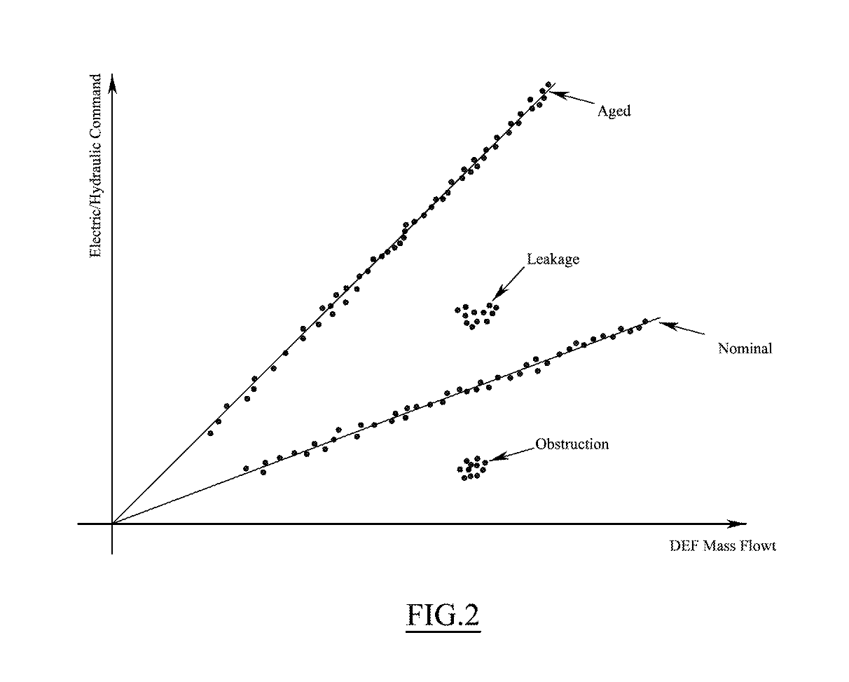

In this way, it is possible to establish, under the predetermined operating condition, a correlation between the requested mass flow rate, which can be seen as a loss in the pressure circuit, in steady state conditions, and the parameter value of the electric signal sent to the transportation device 100, as shown in the graph of FIG. 2 named “Nominal ” A map correlating a DEF mass flow rate fed in the SCR system 4 and the parameter value of the electric signal can be easily determined by the empirical data of the graph named “Nominal” in FIG. 2.

Subsequently the method provides to monitor, during the operation of the diesel engine 1, the parameter value of the electric signal, generated by electronic control module 9, for each Diesel Exhaust Fluid (DEF) mass flow rate fed in the SCR system 4 and to determine, for each Diesel Exhaust Fluid (DEF) mass flow rate fed in the SCR system 4, the difference between the monitored parameter value and the parameter value previously empirically determined, stored in the map, and corresponding to the DEF mass flow rate requested and injected in the SCR system 4. If the difference, which can be positive or negative, exceeds a threshold, a fault is diagnosed. In particular, if the monitored parameter value exceeds the empirically determined parameter value for that requested mass flow rate, a leak is present in the pressure line 7. Otherwise, if the parameter value of the electric signal is lower than the expected one, an obstruction (e.g., freezing) could have happened (FIG. 3).

During normal operation of the diesel engine 1 the parameter value of the electric signal is affected by a certain tolerance due to pressure system components production dispersion and aging, and operating conditions such as, for instance, the operating engine temperature. In order to keep into consideration the above named tolerance of the parameter value of the electric signal, an embodiment of the invention provides that the empirically created map is replaced by a new map correlating a DEF mass flow rate, fed in the SCR system 4, and the parameter value of the electric signal generated by the electronic control module 9 and sent to the transportation device 100, the new map being created with a determined frequency during normal engine operation in steady state conditions.

According to an embodiment the new map is created with a predetermined frequency determined on the basis of the number of hours of operation of the diesel engine 1 or, alternatively, on the basis of the distance covered by a vehicle (not illustrated) provided with the diesel engine 1.

A further embodiment provides for the activation of a warning signal if a fault is diagnosed. The warning signal can be acoustic and/or luminous and it is generated by an alarm device 12 connected to the electronic control module 9.

The method has several important advantages and benefits. First, it allows increasing robustness, reliability, and precision of diesel exhaust fluid injected quantity, also avoiding problems due to injector aging drift. The method can be tailored to any injector characteristic curve, giving the required flexibility to apply it to any vehicle and in particular to automobiles or passenger cars. In addition, the embodiments allow an improvement in NOₓ emissions, ensuring emissions legislation requirements for the vehicles provided with an engine operating according to the embodiments.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for diagnosing a fault in a selective catalytic reduction system connected to a diesel engine, the selective catalytic reduction system having an electric driven transportation device for providing a mass flow of a Diesel Exhaust Fluid into the selective catalytic reduction system, said method comprising:
applying an electric signal to the electric driven transportation device for establishing the mass flow;
monitoring a parameter value of the electric signal;
monitoring the mass flow provided into the selective catalytic reduction system caused by the electric driven transportation device when it is driven with said electric signal;
determining for the mass flow a difference between the parameter value of the electric signal a corresponding parameter value stored in a data map, said data map containing values of said corresponding parameter value that are correlated with the mass flow achieved by said electric driven transportation device when it is driven with the electric signal having the parameter value; and
diagnosing the fault in the selective catalytic reduction system if the difference exceeds a threshold.

2. The method as in claim 1, further comprising empirically determining the data map under a predetermined operating condition of the diesel engine.

3. The method as in claim 1, further comprising:
replacing the data map with a new map correlating a diesel exhaust fluid mass flow rate fed in the selective catalytic reduction system with the parameter value of the electric signal; and
creating the new map being with a determined frequency during normal engine operation.

4. The method as in claim 3, further comprising determining the determined frequency on a basis of hours of operation of the diesel engine.

5. The method as in claim 3, further comprising determining the determined frequency on a basis of a distance covered by a vehicle provided with the diesel engine.

6. The method as in claim 1, comprising activating a warning signal if diagnosing the fault.

7. The method as in claim 1, wherein the electric signal is a power width modulated signal.

8. A computer readable medium embodying a computer program product, said computer program product comprising:
a diagnostic program for diagnosing a fault in a selective catalytic reduction system connected to a diesel engine, the selective catalytic reduction system having an electric driven transportation device for providing a mass flow of a Diesel Exhaust Fluid into the selective catalytic reduction system, the diagnostic program configured to:
apply an electric signal to the electric driven transportation device for establishing the mass flow;
monitor a parameter value of the electric signal;
monitor the mass flow provided into the selective catalytic reduction system caused by the electric driven transportation device when it is driven with said electric signal;
determine for the mass flow a difference between the parameter value of the electric signal a corresponding parameter value stored in a data map, said data map containing values of said corresponding parameter value that are correlated with the mass flow achieved by said electric driven transportation device when it is driven with the electric signal having the parameter value; and
diagnose the fault in the selective catalytic reduction system if the difference exceeds a threshold.

9. The computer readable medium embodying the computer program product as in claim 8, wherein the diagnostic program is further configured to empirically determine the data map under a predetermined operating condition of the diesel engine.

10. The computer readable medium embodying the computer program product as in claim 8, wherein the diagnostic program is further configured to:
replace the data map with a new map correlating a diesel exhaust fluid mass flow rate fed in the selective catalytic reduction system with the parameter value of the electric signal; and
create the new map being with a determined frequency during normal engine operation.

11. The computer readable medium embodying the computer program product as in claim 10, wherein the diagnostic program is further configured to determine the determined frequency on a basis of hours of operation of the diesel engine.

12. The computer readable medium embodying the computer program product as in claim 11, wherein the diagnostic program is further configured to determine the determined frequency on a basis of a distance covered by a vehicle provided with the diesel engine.

13. The computer readable medium embodying the computer program product as in claim 8, wherein the diagnostic program is further configured to activate a warning signal if diagnosing the fault.

14. The computer readable medium embodying the computer program product as in claim 8, wherein the electric signal is a power width modulated signal.
